(19) United States
(12) Patent Application Publication
(10) Pub. No.: US 2021/0214168 A1
(43) Pub. Date: Jul. 15, 2021

(54) FLOW RACK MONITORING SYSTEM

(71) Applicant: ERGOMAT, INC., Lorain, OH (US)

(72) Inventors: JOHN JOSEPH GIRARD, LAKEWOOD, OH (US); CLAUS MUNCH LENDAL, AVON LAKE, OH (US)

(21) Appl. No.: 17/149,626

(22) Filed: Jan. 14, 2021

Related U.S. Application Data
(60) Provisional application No. 62/961,077, filed on Jan. 14, 2020.

(51) Int. Cl. B65G 43/08

(52) U.S. Cl. CPC B65G 43/08; B65G 2203/0233; B65G 2203/047

(57) ABSTRACT

A flow rack monitoring system includes: at least one sensor assembly having a kinetic switch protectively enclosed within a mounting shell mounted to a flow rack to monitor movement of an item therealong, wherein a lever of a kinetic switch thereof is connected to an elongate whisker within a slot of the mounting shell, and wherein a transmitter of the kinetic switch transmits a first RF signal in response to movement of the lever away from a resting position, and a second RF signal in response to movement into the resting position; and an alert device having a processor to receiver the first and second RF signals, and to provide an indication of an item becoming stuck in response to the receipt of the first RF signal, followed by a lack of receipt of the second RF signal from the first sensor assembly within a first predetermined period of time.

### REFERENCE TO PROVISIONAL APPLICATION

This application is related to, and claims the benefit of the filing date of, U.S. Provisional Application Ser. No. 62/961,077 (Atty's Docket No. 7-330) filed Jan. 14, 2020 by John Joseph Girard et al., the disclosure of which is incorporated herein by reference.

### BACKGROUND

What is disclosed herein relates to the field of materials handling—specifically to the monitoring of movement of items on flow racks.

Monitoring systems for the monitoring of movement of objects on flow racks, and other varieties of conveyor systems, are well known, but are often expensive and complex to install. Indeed, it is frequently the case that such monitoring systems require the reliance on expert personnel to effect the installation of such systems. And yet, even with the help of professionals, it is not unheard of to have such installation efforts beset with configuration difficulties that can actually delay the use of whole flow rack systems while efforts must be made to “chase the bugs out” of such systems.

Many current day systems for monitoring the movement of objects along paths on flow racks and similar conveyance systems employ relatively expensive optical sensors that must be aligned with corresponding reflector components. Alternatively or additionally, many current day systems employ relatively expensive optical scanning components that must have their fields of view (FOVs) individually configured for the circumstances under which each is used to monitor the movement of objects therethrough.

What remains unaddressed is a need for a relatively inexpensive flow rack monitoring system employing relatively simple and inexpensive components that quickly and easily installed, and that are relatively easily maintainable.

### SUMMARY

What is disclosed herein includes sensor assemblies and other components of a flow rack monitoring system configured to be quickly and easily installed to monitor the movement of items on a flow rack or a system of flow racks.

A flow rack monitoring system incorporates an alert device installed in the vicinity of where a flow rack is used, and one or more whisker sensors that are positioned at various locations along the flow rack. Such a flow rack monitoring system may be employed in a warehouse, a sorting facility, a shipping facility (e.g., a cargo facility of an airport) or other industrial environment in which one or more flow racks are employed to move items among locations within a facility and/or to move items among vehicles that may be used in shipping those items. Where such flow racks are used, there may be a risk of items becoming stuck and/or jammed at various locations along a flow rack, and/or a risk of items falling off of a flow rack.

More specifically, sensor assemblies may be attached to the frames of one or more flow racks at various locations to enable the detection of the movement of items therealong. The mechanism of attachment of each sensor assembly may entail the use of a magnet, clamp or other gripping or fastening hardware that enables the subsequent removal of the sensor assembly with minimal or no damage to the framework of a flow rack. Each sensor assembly may incorporate a kinetically-powered whisker sensor that includes a lever that is normally spring-biased to a resting position, where movement of the lever from and to the resting position is used to internally generate electrical energy that is employed to power an internal radio frequency (RF) transmitter to wirelessly transmit an RF signal indicative of each such movement.

A curving elongate, rod-like piece of lightweight material may be sleeved onto (or otherwise attached to) the lever of a whisker sensor to extend the length of the lever and thereby form a whisker that imparts movement to the lever in response to contact by the whisker with another object. The sensor assembly may also incorporate a mounting shell that serves to protectively encase at least a portion of the whisker sensor, and to enable the whisker sensor to be mounted to the frame of flow rack. A whisker slot may be defined by the mounting shell by which the whisker may be physically supported in a manner that prevents the whisker sensor from being subjected to various physical forces that may be exerted on the whisker. More precisely, the whisker slot may allow certain forces exerted on the whisker in certain directions to be transmitted by the whisker to the lever to cause movement of the lever from and to the resting position, while preventing other forces exerted on the whisker in other directions from being transmitted to the lever (or at least mitigating such transmission of such other forces).

With a whisker sensor so encased within a mounting shell, and with a whisker attached to its lever, the resulting sensor assembly may be attached to a portion of the framework of a flow rack at a location, and in an orientation, that causes the whisker to extend into the path that an item may follow as it is moved along the flow rack. This enables the whisker to be encountered by an item as the item moves past the location at which the sensor assembly is positioned to cause the movement of the item past that location to be detected. With multiple ones of such sensor assemblies similarly installed at various locations along a flow rack (or set of flow racks), the movement of the item therealong can be detected and monitored. Additionally, instances in which an item moves only part of the way therealong as a result of becoming stuck at a location therealong, or as a result of having fallen off a flow rack, can be detected.

An alert device may be installed and/or otherwise maintained (e.g., may be carried as portable device by an operator) in the vicinity of the one or more flow racks that are so monitored. The alert device may incorporate a speaker and/or a display to provide an audible and/or visual alert of an item apparently becoming stuck and/or lost along the length of a flow rack in response to the receipt of an RF signal, and/or in response to the lack of receipt of an RF signal, from a whisker sensor. Such a display may include a separate visual indication for each whisker sensor to enable an operator of the one or more flow racks to be provided with an indication of the general location at which an item may have become stuck and/or at which an item may have become lost.

A wireless pairing process may be used to enable wireless RF communications between the whisker sensor(s) that are installed at various locations along one or more flow racks and the alert device. Each whisker sensor may be provided with a universal identifier that uniquely identifies the whisker sensor, and that is included in each RF signal that the whisker sensor transmits. The alert device may incorporate one or more manually-operable controls that enable the alert device to be placed in a pairing mode in which it may be caused to recognize the RF signals transmitted by each whisker sensor that installed at a location along a flow rack. The alert device may also be caused to match each such whisker sensor to a particular location along one or more flow racks to enable the identification of individual flow rack locations on the display.

As an alternative to, or in addition to, the alert device, itself, providing an alert to the operator of one or more flow racks, the alert device may be connected to a controller of the one or more flow racks. In response to the receipt of an RF signal from a whisker sensor, and/or in response to the lack of receipt of an expected RF signal from a whisker sensor, the alert device may cooperate with such a controller to cause operation of a speaker and/or lights of the controller to provide an alert when it appears that an item has become stuck and/or lost along a portion of a flow rack, and/or to cause operation of a motor(s) of one or more motorized flow racks to stop.

### BRIEF DESCRIPTION OF THE DRAWINGS

A fuller understanding of what is disclosed in the present application may be had by referring to the description and claims that follow, taken in conjunction with the accompanying drawings, wherein:

FIG. 1A is a block diagram of a flow rack monitoring system employed in monitoring the movement of an item on a flow rack.

FIG. 1B is a perspective view of a component of the flow rack system of FIG. 1A amidst portions of a flow rack.

FIG. 1C is a sequence of block diagrams depicting aspects of the operation of the flow rack system of FIG. 1A.

FIG. 2A is a perspective view of an embodiment of a whisker sensor usable as part of the flow rack system of FIG. 1A.

FIG. 2B is a block diagram of an internal architecture of the whisker sensor of FIG. 2A.

FIG. 3A is an exploded perspective view of an embodiment of a mounting shell usable to protectively enclose and quickly mount the whisker sensor of FIGS. 2A-B in place relative to a flow rack as part of assembling an embodiment of the flow rack monitoring system of FIGS. 1A-C.

FIG. 3B is a perspective view of the mounting shell of FIG. 3A in assembled form with the whisker sensor of FIGS. 2A-B enclosed therein.

FIG. 3C is a perspective view of the assembled mounting shell of FIG. 3B accompanied by an optional third component thereof providing a tube clamp.

FIG. 4A is a block diagram of an internal architecture of an embodiment of an alert device usable as part of the flow rack system of FIG. 1A.

FIG. 4B is a perspective view of the alert device of FIG. 4A.

FIG. 5 is a block diagram depicting aspects of interactions among components of the flow rack monitoring system of FIGS. 1A-C and components of a flow rack or a flow rack system.

### DETAILED DESCRIPTION

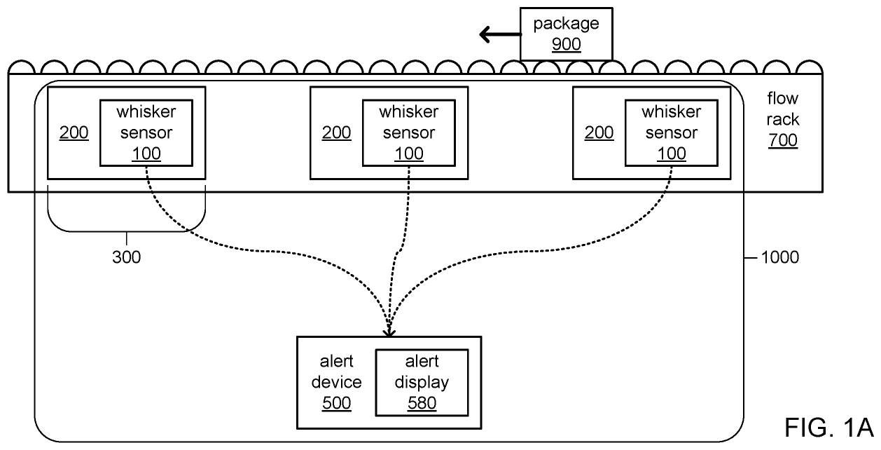

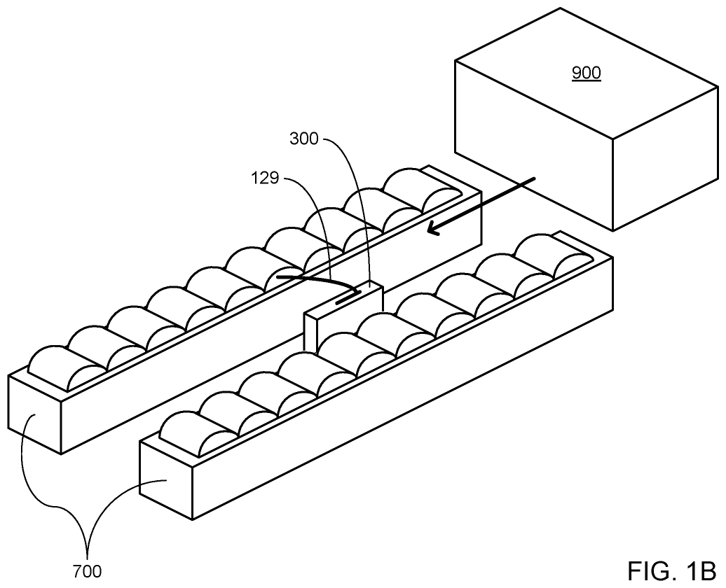

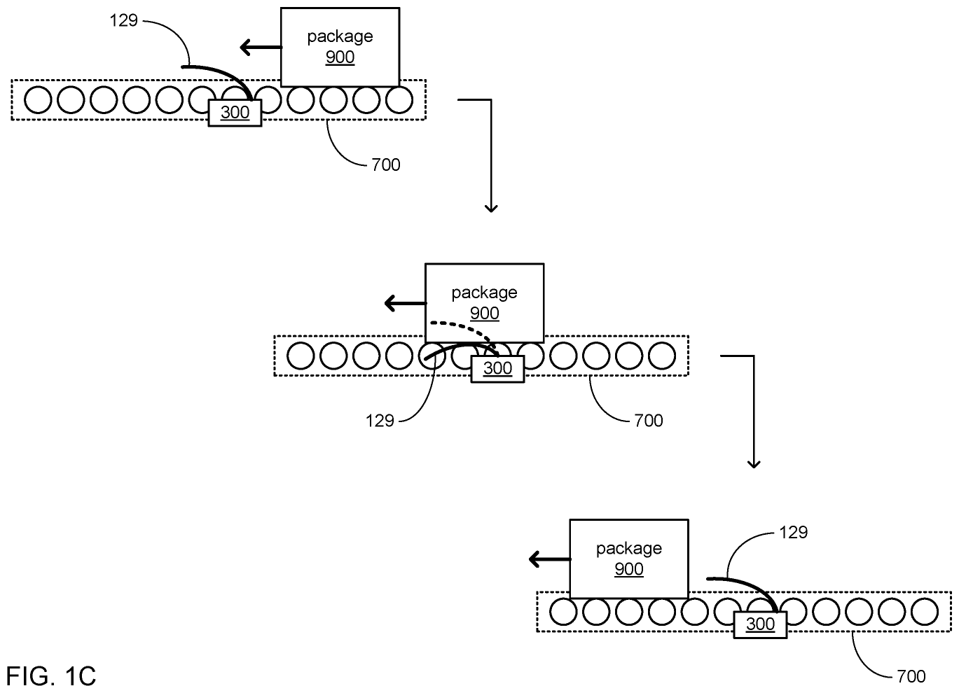

Turning to FIGS. 1A through 1C, an example embodiment of a flow rack monitoring system 1000 is depicted as having been installed on a single flow rack 700. As depicted, the flow rack 700 may include a single frame supporting multiple rollers to enable an item 900 (e.g., a package 900) to be moved therealong in a direction depicted by an arrow. It should be noted that the depicted flow rack 700 is a deliberately simplified example thereof that is provided for purposes of enabling discussion and understanding of the flow rack monitoring system 1000, and should not be taken as limiting the variety of types and/or configurations of either a single flow rack 700, or of multiple flow racks 700, with which the system 1000 may be used. It should also be noted that, despite the depiction of the flow rack monitoring system 1000 as being installed on a single flow rack 700, other embodiments are possible in which the flow rack monitoring system 1000 is installed on multiple flow racks 700 that may cooperate to define one or more paths along which items 900 may be moved.

As is depicted more clearly in FIG. 1A, the flow rack monitoring system 1000 may incorporate an alert device 500, and one or more sensor assemblies 300 that may be installed at various locations along one or more flow racks 700 that define a path that may be taken by the item 900. As will be explained in greater detail, each of the sensor assemblies 300 may incorporate a whisker sensor 100 carried within a mounting shell 200 by which the whisker sensor 100 is attached to a portion of the frame of the flow rack 700 (or of one of multiple flow racks 700). As will also be explained in greater detail, each whisker sensor 100 may wirelessly transmit RF signals to the alert device 500 in response to detecting the item 900 arriving at and/or leaving the flow rack location at which that whisker sensor 100 is installed.

As is depicted more clearly in FIG. 1B, a sensor assembly 300 may be positioned among the rollers of a flow rack 700 (e.g., between two lines of rollers of a flow rack 700) at a location and with an orientation that causes the curving rod-like whisker 129 thereof to extend into the path (indicated by the depicted arrow) that the item 900 may take while moving along that flow rack 700. As a result, the item 900 makes physical contact with the whisker 129, thereby momentarily pushing the whisker 129 out of the way of its path of movement, as the item 900 continues to move therealong.

As is depicted more clearly in both FIG. 1C, such a whisker 129 may extend generally vertically, but with an orientation that causes its curving orientation to curve out of its initially vertical orientation and into a generally horizontal direction in which the whisker 129 effectively “points” in the direction in which the item 900 is to travel as it moves along its path (again indicated by the depicted arrows). This curving orientation, while serving to position the whisker 129 in the path of movement of the item 900, also allows the item 900 to easily push the whisker 129 out of its path, thereby aiding in preventing the whisker 129 from pushing the item 900 out of its path of movement (such that the item 900 may be pushed off of the flow rack 700, and thereby potentially become lost), and aiding in preventing the whisker 129 from causing the item 900 to become stuck along its path of movement.

As a result of the contact with the item 900, the whisker 129 is caused to be moved away from its original position by the force of being pushed out of the way of the path of movement of the item 900, as can be seen by contrasting the positions of that particular whisker 129 depicted in FIG. 1C, where the original resting position of the whisker 129 is depicted with a dotted line. As will be explained in greater detail, the kinetic energy of that particular whisker 129 being so moved out of its resting position by contact with the item 900 may be converted within the corresponding whisker sensor 100 into electrical energy that is used to transmit a first RF signal. Then, after the item 900 ceases to be in contact with the whisker 129, a spring or other elastic member of the whisker sensor 100 may act to urge the whisker 129 back into its resting position, and the kinetic energy of that return movement may also be converted into electrical energy used to transmit a second RF signal.

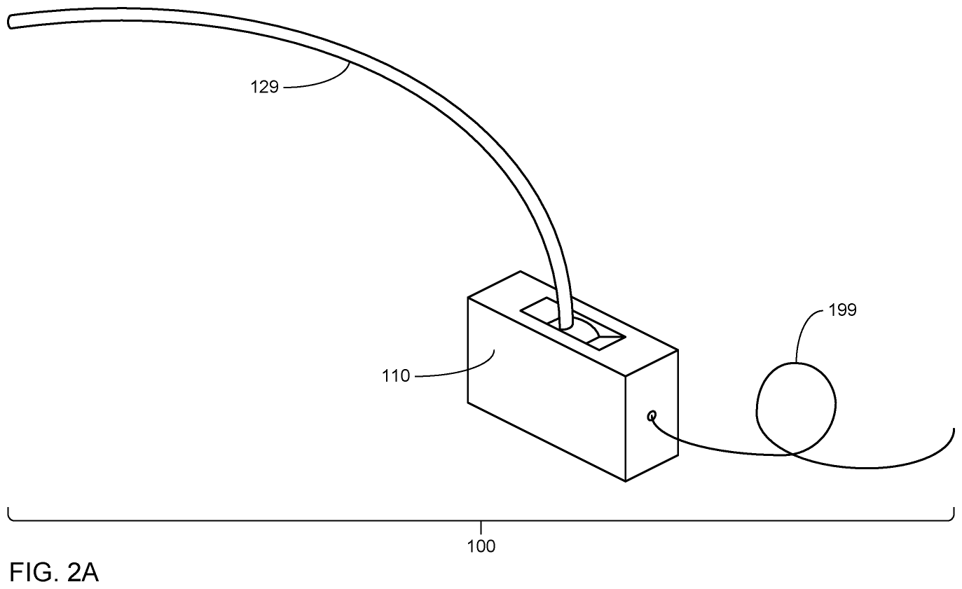

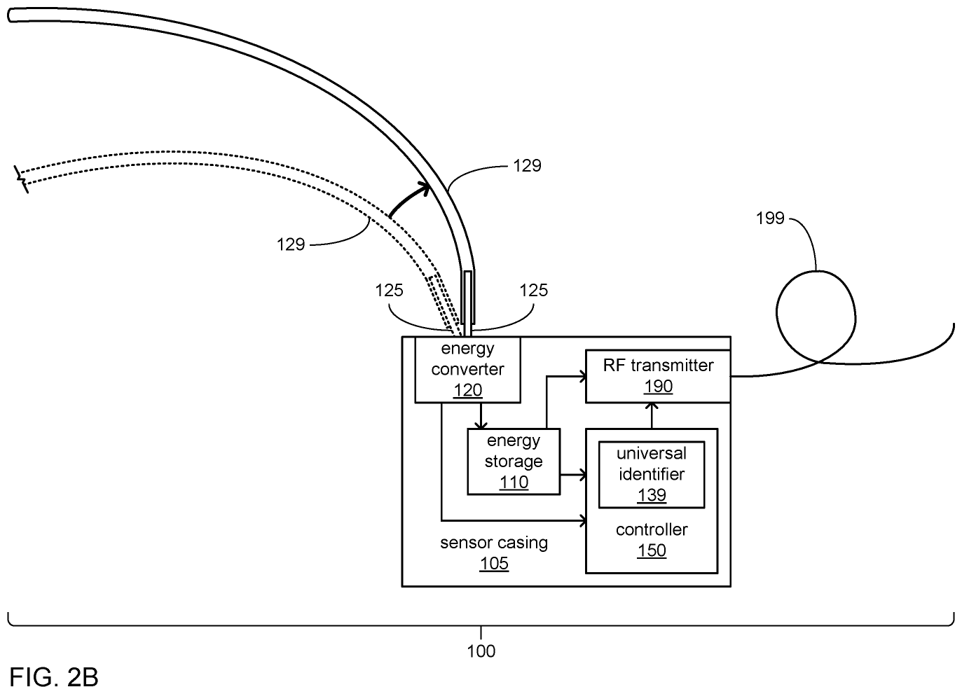

Turning to FIGS. 2A and 2B, an example of embodiment of the whisker sensor 100 is depicted as having a casing 150 of a generally rectangular box-like shape from which a lever 125 and an RF antenna 199 emanate. Within the casing 105, the whisker sensor 100 may incorporate an energy converter 120 to convert the kinetic energy associated with movement of the lever 125 into electrical energy, an energy storage 110 to temporarily store the electrical energy, and a combination of a controller 150 and an RF transmitter 190 to cooperate in using the stored electrical energy to wirelessly transmit an RF signal that includes a universal identifier 139 via the RF antenna 199. As will be familiar to those skilled in the art, the whisker sensor 100 may alternately be referred to as a “kinetic switch” in recognition of such use of kinetic energy to provide the electrical energy needed to make such a wireless transmission.

As is depicted, the lever 125, together with the depicted whisker 129 attached thereto, may be able to be pivoted relative to the casing 105 between a resting position (depicted in solid lines), to which the combination of lever 125 and whisker 129 may be biased by an internal spring or other elastic component (not shown), and another, non-resting, position (depicted in dotted lines) to which this combination may be moved against such a biasing force. However, it should be noted that other embodiments of the whisker sensor 100 may be possible in which the combination of lever 125 and whisker 129 may be slidable relative to the casing 105 between a resting position and another position. As another alternative, it may be that the lever 125 is replaced by a rotatable shaft (not shown) that may be rotatable relative to the casing 105 between a resting position in one orientation and another position in a different orientation.

Regardless of the exact manner in which the lever 125 (or a shaft in lieu of the lever 125) may be movable relative to the casing 105, and therefore, regardless of the exact type of movement that is caused to occur relative to the casing 105, the energy converter 120 may employ a combination of one or more electric coils and one or more permanent magnets to convert the kinetic energy of whatever movement of the lever 125 is caused to occur into electrical energy. Stated differently, and as will be familiar to those skilled in the art, the energy converter 120 may be a form of electric generator.

The energy storage 110 may be made up of any of a variety of electronic components that are capable of temporarily storing the electricity generated by the energy converter 120. By way of example, the energy storage 110 may incorporate one or more capacitors and/or ultra-capacitors, one or more coils, and/or one or more rechargeable batteries that may be based on any of a variety of energy storage technologies. As those skilled in the art will readily recognize, the manner in which the lever 125 may be moved from and to its resting position may vary greatly in such characteristics as speed of movement, extent of movement and/or steadiness of movement (e.g., whether the movement is of constant or varying speed). More specifically, and referring momentarily back to FIGS. 1B-C, the manner in which the whisker 129 may be moved may vary greatly depending on the manner in which the item 900 comes into contact with the whisker 129 (e.g., at what speed, with what surface and/or at what orientation, etc.). As a result, the electricity produced from such movement by the energy converter 120 may be unpredictable in such characteristics as voltage, amperage, duration in time and/or steadiness of such characteristics (e.g., whether the voltage and/or amperage are constant or varying).

However, while the energy converter 120 may, therefore, be caused to provide electrical energy with what may be widely varying characteristics, the controller 150 and/or the RF transmitter 190 may require electrical energy having somewhat more particular characteristics (e.g., a voltage and/or amperage within a specific range). Therefore, it may be deemed desirable to employ the energy storage 110 to receive the electrical energy generated by the energy converter 120 with widely varying characteristics, store it, and then provide it to the controller 150 and/or the RF transmitter 190 with characteristics that are more compatible therewith.

The controller 150 may incorporate a relatively simple microprocessor, microcontroller, sequencer, discrete and/or programmable logic, etc., that may be designed and/or selected, at least in part, to consume a minimal amount of electrical energy. This may be deemed desirable in view of the relatively limited amount of electrical energy that may be expected to be generated from the relatively limited and brief movement of the lever 125 from its resting position, and then subsequently back to its resting position. Similarly, the RF transmitter 190 may be designed and/or selected also, at least in part, to consume a minimal amount of electrical energy.

Regardless of the details of the design and/or selection of components for the controller 150 and/or the RF transmitter 190, in some embodiments, separate RF signals may be wirelessly transmitted for the movement of the lever 125 from its resting position and for the subsequent movement of the lever 125 back to its resting position. This may be deemed desirable to ensure that at least one RF signal is transmitted in a situation in which the whisker 129 is caused to be moved from the resting position (thereby moving the lever 125 out of its resting position), and then somehow becomes stuck or otherwise restrained such that a return under the biasing force to the resting position is prevented.

The controller 150 may incorporate nonvolatile storage based on any of a variety of technologies (e.g., PROM, EPROM, FLASH, etc.) to store the universal identifier 139. It may be that the manufacturer of the whisker sensor 100 generates a unique numeric or alphanumeric data value as the universal identifier 139 for each whisker sensor 100 that is manufactured. The universal identifier 139 may, therefore, be permanently stored within each whisker sensor 100 as it is manufactured.

When the lever 125 is moved out of its resting position, the movement may be converted by the energy converter 120 into electrical energy, which is then stored by the energy storage 110. The energy storage 110 may then provide the stored electrical energy to the controller 150 and the RF transmitter 190 to enable their cooperation to wirelessly transmit an RF signal. The controller 150 may cooperate with the energy converter 120 to determine the current position of the lever 125. In response to determining that the lever 125 has been moved out of the resting position, the controller 150 may cooperate with the RF transmitter 190 to wirelessly transmit (via the RF antenna 199) an RF signal that includes the universal identifier 139 and an indication that the lever 125 has been moved out of its resting position.

Subsequently, when the lever 125 is allowed (under the biasing force of a built-in spring or other elastic component, not shown) to move back into its resting position, this other movement may also be converted by the energy converter 120 into electrical energy, which is then stored by the energy storage 110. Again, the energy storage 110 may then provide the stored electrical energy to the controller 150 and the RF transmitter 190 to enable their cooperation to wirelessly transmit an RF signal. Again, the controller 150 may cooperate with the energy converter 120 to determine the current position of the lever 125. In response to determining that the lever 125 has been moved back to the resting position, the controller 150 may cooperate with the RF transmitter 190 to wirelessly transmit (via the RF antenna 199) another RF signal that again includes the universal identifier 139, but which also includes an indication that the lever 125 has been moved back to its resting position.

In an alternate variant of the whisker sensor 100, it may be that two different universal identifiers 139 are assigned thereto. In such an alternate variant, it may be that one of those universal identifiers 139 is transmitted in response to a determination that the lever 125 has been moved out of its resting position, and that the other those universal identifiers 139 is transmitted in response to a determination that the lever 125 has been moved back to its resting position.

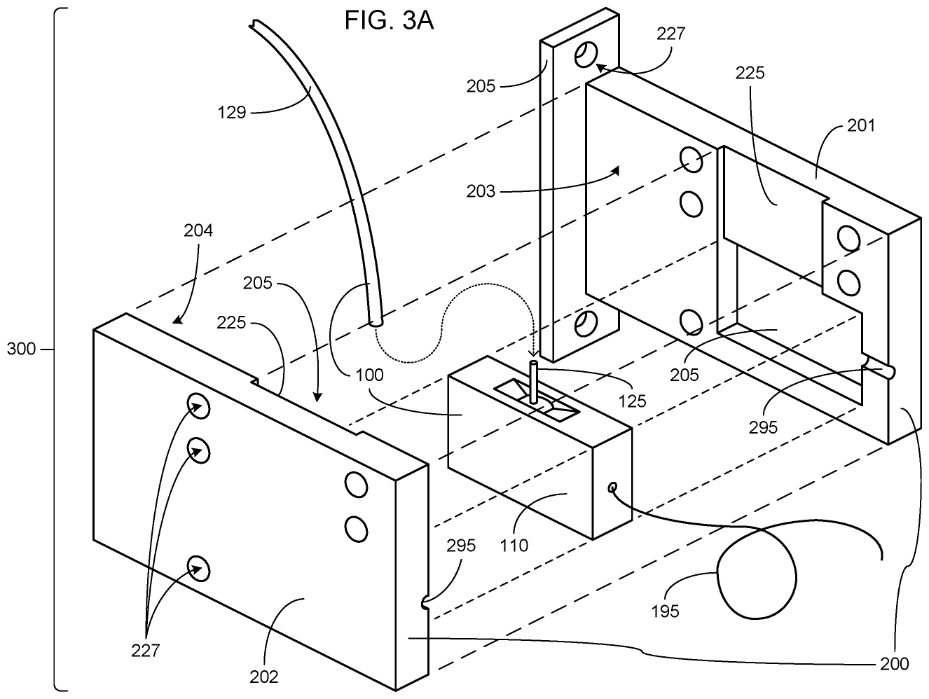

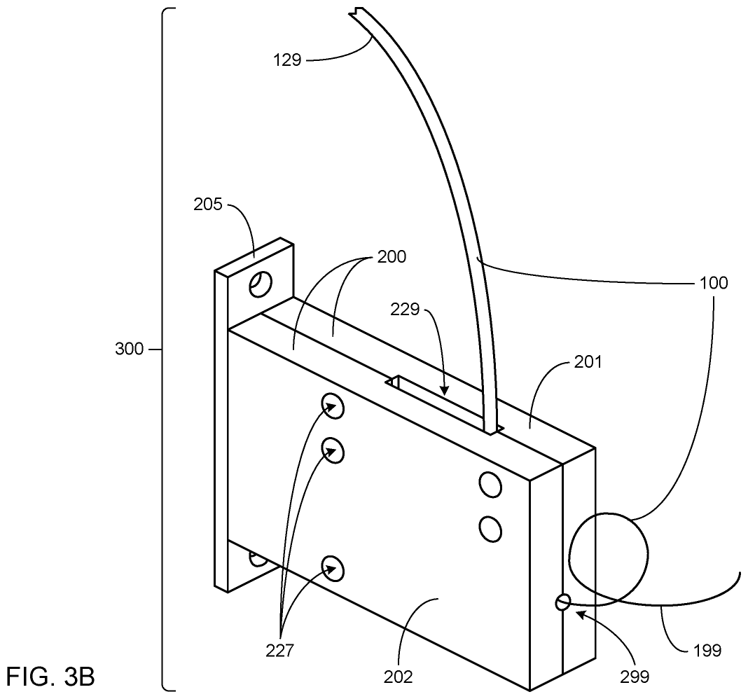

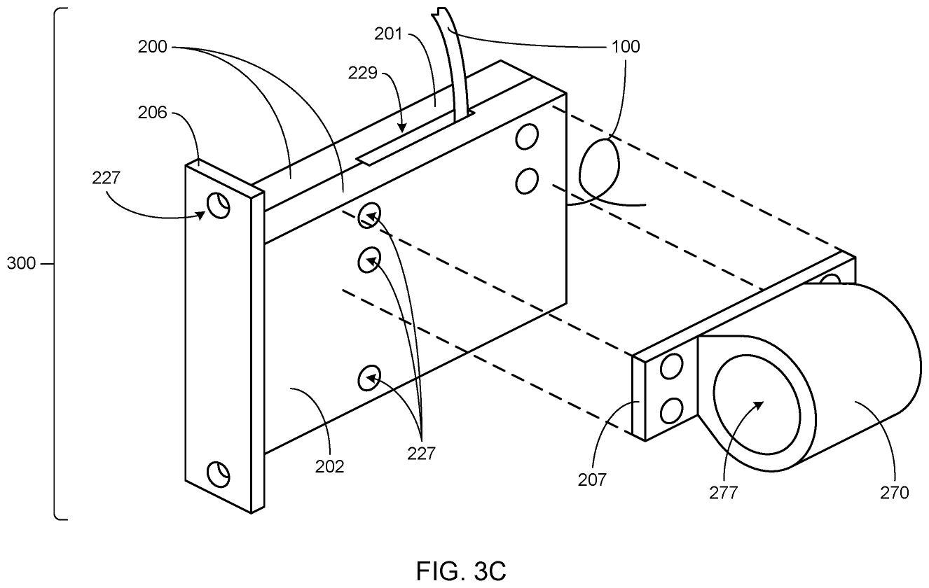

Turning to FIGS. 3A, 3B and 3C, an example embodiment of the mounting shell 200 is depicted as having a generally rectangular box-like shape that defines a cavity 205 in which the casing 105 of the whisker sensor 100 may be protectively enclosed, while enabling the whisker sensor 100 to be attached to, and thereby carried on, a portion of the frame of a flow rack 700. The combination of the whisker sensor 100 so enclosed within the mounting shell 200 may form the sensor assembly 300. However, it should be noted that, despite the depiction of this particular shape for the mounting shell 200, with a particular combination and arrangement of mounting features enabling such attachment to a portion of a flow rack 700, other embodiments of the mounting shell 200 are possible that each may have a different overall shape, and/or a different combination and arrangement of mounting features.

As depicted, the mounting shell 200 may be formed, primarily, as a pair of shell components 201 and 202 that may be assembled to form at least a core portion of the mountain shell 200 when inner opposed facing surfaces 203 and 204, respectively, are brought together. As is also depicted, a portion of the cavity 205 may be formed in each of the inner opposed facing surfaces 203 and 204 with a shape and size that causes the cavity 205 to closely surround the casing 105 of the whisker sensor 100. Each of the shell components 201 and 202 may be formed from a relatively stiff material selected to be strong enough to protect the whisker sensor 100 from a variety of physical impacts, including from a range of items 900 that may be moved along a flow rack 700. Matching channels 295 may also be formed in each of the inner opposed facing surfaces 203 and 204 that cooperate to form a passage 299 through which the RF antenna 199 of the whisker sensor 100 may extend from within the cavity 205 and into the surrounding environment. Similarly, matching channels 225 may also be formed in each of the inner opposed facing surfaces 203 and 204 that cooperate to form a slot opening 229 into which end portions of the lever 125 and the whisker 129 may extend, and/or in which end portions of the lever 125 and the whisker 129 may be connected.

Each of the two matching channels 225 formed in the inner opposed facing surfaces 203 and 204 may be shaped and sized to cause the resulting slot 229 to closely circumscribe the full extent of the movement of the end portion of the whisker 129 that is connected to the lever 125 as determined by the extent of the range of movement of the lever 125 between its resting position and the its non-resting position. In this way, the shape and size of the slot 229 serves to prevent (or at least limit) the exertion of forces on the lever 125 that might otherwise force movement of the lever 125 beyond and/or outside the limited range of movement that the lever 125 is intended to have along a pathway between the resting and non-resting positions, thereby potentially damaging the lever 125 and/or other components of the whisker sensor 100 within the casing 105. Thus, where an external force exerted on the whisker 129 attempts to move the lever 125 beyond and/or outside its intended range of movement, the end portion of the whisker 129 connected to the lever 125 is caused to encounter an edge of the slot 229, thereby preventing such extraneous movement of the lever 125.

The whisker 129 may be formed from a relatively lightweight material to minimize the amount of weight and/or other inertial forces that it may exert on the lever 125. The material from which the whisker 129 is formed may also be selected to achieve a balance between flexibility and stiffness to thereby cause the whisker to be stiff enough to maintain a curving rod-like shape that extends at least partially vertically into the path of an item 900 moving along a flow rack 700, while also causing the whisker 129 to be flexible enough to be bent in various directions to allow the item 900 to push the whisker 129 aside without damage to the item 900. The degree of flexibility may also be selected to avoid the whisker 129 being stiffer or stronger than the material from which the mounting shell 200 is formed such that the whisker 129 has a tendency to at least bend, rather than to transmit sufficient force to cause a portion of the mounting shell 200 to bend and/or to damage the mounting shell 200. Stated differently, it may be deemed desirable for the whisker 129 to be flexible enough to bend or break in response to the exertion of a high magnitude of force thereon before such a force is able to cause damage to portions of the mounting shell 200 that define the slot 229 and/or to the lever 125. Thus, the whisker 129 may be deemed a “sacrificial” component that is meant to be replaced relatively easily, if need be, following instances in which the whisker 129 may be subjected to forces of high magnitude, such as may be exerted on the whisker 129 by a particularly heavy item 900.

As is further depicted, various passages 227 may be formed through various portions of the mounting shell 200 to enable attachment of the mounting shell 200 to a portion of the frame of a flow rack 700 using any of a variety of fasteners that may extend through one or more of the passages 227 (e.g., screws, bolts, pins, rivets, zip ties, straps, wire, twine, etc.). Alternatively or additionally, a flange 206 may be formed along one side and/or edge of the exterior of the mounting shell 200. Such a flange 206 may be used with one or more clamps and/or clips (not shown) to attach the mounting shell 200 to a portion of a frame of a flow rack 700. Further, one or more of the passages 227 may be formed through portions of such a flange 206.

As is depicted more clearly in FIG. 3C, the core portion of the mounting shell 200 that may be defined by the shell components 201 and 202 may be augmented with the addition of a third shell component 207 that carries a tubing clamp 270 by which the sensor assembly 300 may be mounted onto a tube-like portion of a frame of a flow rack 700 and/or onto a tube-like mounting component that is, itself, mounted onto a portion of a frame of a flow rack 700. More specifically, the tubing clamp 270 may be shaped to provide a passage 277 through which a tube (not shown) may extend to enable it being engaged by the tubing clamp 270 as part of mounting the third shell component 207 of a mounting shell 200 of a sensor assembly 300 to a frame of a flow rack 700, where the tube so engaged may either be portion of that frame or a tubular mounting component that may, itself, be mounted to a portion of that frame. As depicted, the third shell component 207 may be attached to the core portion of the mounting shell 200 via a flange and the use of fasteners extended through passages 227 and/or via another attachment mechanism (not shown).

Each of the shell components 201, 202 and/or 207 may be formed from any of a variety of relatively lightweight materials, such as a plastics and/or ceramic materials, and/or still other materials, that serve to give the mounting shell 200 a sufficiently light weight as to enable the attachment of the mounting shell 200 to a portion of a frame of a flow rack 700, including through use of a magnet (not shown). However, it should be noted that other embodiments are possible in which the mounting shell 200 may be formed from any of a variety of other materials and/or combinations of materials.

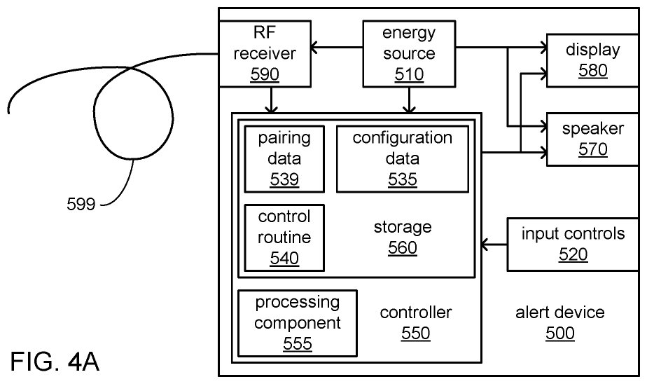

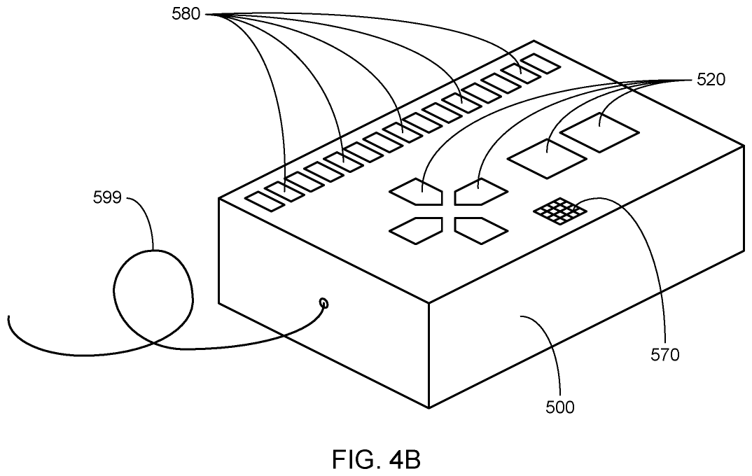

Turning to FIGS. 4A and 4B, an example of embodiment of the alert device 500 is depicted as having a generally rectangular box-like casing from which an RF antenna 599 emanates. As depicted, the alert device 500 may incorporate an RF receiver 590 to receive the RF signals transmitted by one or more of the whisker sensors 100 via the RF antenna 599, a controller 550, a speaker 570 and/or a display 580 that can provide an audible and/or visual indication of the receipt of an RF signal from such a whisker sensor 100, and one or more manually-operable input controls 520 by which various functions of the alert device 500 and/or of the entire flow rack monitoring system 1000 may be manually controlled.

The controller 550 may incorporate a processing component 555 and a storage 560 that is accessible to the processing component 555, and that stores configuration data 535, pairing data 539 and/or a control routine 540. The processing component 555 may be any of a variety of types of processing component, including and not limited to, a microprocessor, microcontroller, sequencer, etc.

The control routine 540 may include executable instructions that are operable on the processor 555 to cause the processor 555 to perform various operations. Among those operations may be determining whether each received RF signal emanates from a particular whisker sensor 100 with which the alert device 500 has been paired, and/or providing an indication of the occurrence of various events concerning the movement of items along one or more flow racks 700.

As is also depicted, the alert device 500 may incorporate an energy source 510 to provide electrical energy to one or more of these components of the alert device 500. The energy source 510 may be any of a variety of rechargeable and/or non-rechargeable batteries, or other form of portable energy storage. Such an energy source 510 may, therefore, need to be replaced and/or recharged from time to time. Alternatively, the energy source 510 may actually be external to the alert device 500, such as where the energy source 510 is and/or uses AC mains.

As previously discussed, when a lever 125 of a whisker sensor 100 installed at a location on the frame of a flow rack 700 is caused to be moved out of its resting position as a result of its corresponding whisker 129 being moved out its resting position by an item 900 being moved along the flow rack 700, that whisker sensor 100 may wirelessly transmit an RF signal conveying its universal identifier 139 and an indication of its lever 125 having been so moved (or may wirelessly transmit an RF signal conveying one of two universal identifiers 139 that is associated with such movement away from a resting position). Correspondingly, when the lever 125 of that whisker sensor 100 is allowed to move back to its resting position under the biasing force of a spring or other elastic component, that whisker sensor 100 may then wirelessly transmit another RF signal again conveying its universal identifier 139, but with an indication of its lever 125 having moved back to its resting position (or may wirelessly transmit another RF signal conveying the other of two universal identifiers 139 that is associated with such movement back to a resting position).

Via the RF antenna 599, the receiver 590 may receive each such RF signal, and may perform the demodulation and/or other decoding needed to extract the universal identifier 139 and/or accompanying indication of the type of movement of the lever 125 that occasioned the transmission thereof. Upon being provided with the retrieved universal identifier 139, the processing component 555 may be caused, by its execution of the control routine 540, to compare the retrieved universal identifier 139 to a set of universal identifiers within the pairing data 539 to determine whether the received RF signal was transmitted by a whisker sensor 100 with which the alert device 500 has been paired. If so, then the processing component 555 may be caused to analyze the accompanying indication of the type of movement of the lever 125 (or analyze the inherent indication of the type of movement of the lever 125 associated with the choice of which of two universal identifiers 139 was sent) to determine whether the indication is of the lever 125 having been moved away from or back to its resting position.

In addition determining what movement is indicated in the received RF signal, the processing component may 555 also be caused to use this determination in conjunction with other determinations of what movements may have been indicated, and/or are next expected to be indicated, as being associated with the same lever 125 of the same whisker sensor 100 and/or with other lever(s) 125 of other whisker sensor(s), as part of making a determination as to whether an item 900 has become stuck along its path along one or more flow racks 700 and/or has been somehow lost along that path.

More specifically, and by way of example, where the processing component 555 has determined that a first RF signal indicating movement of a lever 125 of a whisker sensor 100 out of its resting position has been received, followed by a second RF signal indicating movement of the same lever 125 of the same whisker sensor 100 back into its resting position having been received, the processing component 555 may then be caused to determine that an item 900 has successfully passed the location of that whisker sensor 100 along a flow rack 700. However, if the processing component 555 then determines that too much time has elapsed since the receipt of the second RF signal without a third RF signal being received from the next whisker sensor 100 at the next location on a flow rack 700 through which that same item 900 must pass as it continues on its path, then the processing component 555 may be caused to operate the speaker 570 and/or the display 580 to provide an indication of the possibility that the item has become stuck along its path at a location between the two whisker sensors 100 (e.g., has somehow become caught at a location therebetween on a flow rack 700), and/or has become lost along its path therebetween (e.g., has somehow fallen off a flow rack 700 at a location therebetween).

By way of another example, where the processing component 555 has determined that a first RF signal indicating movement of a lever 125 of a whisker sensor 100 out of its resting position has been received, followed by the passage of an excessive amount of time without receipt of a second RF signal indicating movement of the same lever 125 of the same whisker sensor 100 back into its resting position, the processing component 555 may then be caused to determine that an item 900 has become stuck at the location of that whisker sensor 100 along a flow rack 700. The processing component 555 may then operate the speaker 570 and/or the display 580 to provide an indication of the possibility that the item 900 has become stuck along its path at the location of that whisker sensor 100 (e.g., has somehow become caught at that location on a flow rack 700).

In providing an audible indication of an alert, the speaker 570 may simply be operated by the processing component 555 to produce an alert sound. Similarly, the display 580 may be little more than a single light bulb, light-emitting diode (LED) or other light-emitting component that is caused to output light of a chosen color as an alert color.

Alternatively or additionally, the audible indication provided by the processor component 555 through the speaker 570 and/or the visual indication provided by the processor component 555 through the display 580 may identify which of multiple whisker sensors 100 installed on one or more flow racks 700 is the whisker sensor 100 at the location at which an item 900 may have become stuck and/or lost, and/or may identify which two adjacent whisker sensors 100 are at the locations between which an item may have become stuck and/or lost. By way of example, the speaker 570 may be operated to produce any of an assortment of different sounds that may identify the particular one or two whisker sensors 100, such as an assortment of differing quantities and/or patterns of beeps, an assortment of different tone frequencies, and/or synthesized speech in which identifier(s) of the particular one or two whisker sensors 100 is specified with spoken number(s) and/or word(s).

Also by way of example, and as is depicted more clearly in FIG. 4B, the display 580 may be made up of multiple light-emitting components (e.g., multiple LEDs) that may be positioned in a manner that is meant to be visually indicative of the relative positions of the whisker sensors 100 along a path that may be defined by one or more flow racks 700 for an item 900 to be moved therealong. FIG. 4B depicts a single line of such light-emitting components of one example of such a display 580 where each of the locations along a flow rack 700 (or along multiple flow racks 700) at which a whisker sensor 100 is installed is associated with one of the light-emitting devices, and the selection of which one (or which adjacent pair) is lit provides a visual indication of where an item 900 may have been lost along the path, either at the flow rack location of a single whisker sensor 100 or between the flow rack locations of two adjacent whisker sensors 100. Additionally, each of such light-emitting components may be caused to emit light of a different color to indicate whether that movement of the lever 125 thereof is away from or into a resting position.

Regardless of the exact manner in which particular flow rack locations and/or particular whisker sensors 100 may be identified audibly and/or visually, the processing component 555 of the controller 550 may be caused by execution of the control routine 540 to maintain the configuration data 535 by which the universal identifier(s) 139 of each whisker sensor 100 that is included in the pairing data 539 may be matched by the processor component 555 to a particular flow rack location at which it is installed. Thus, when an audible and/or visual alert is to be provided, the processing component 555 may be caused to refer to the configuration data 535 to determine which flow rack location(s) and/or whisker sensor(s) is/are the one(s) with which the alert should be audibly and/or visually associated. As part of providing the associations that are to be stored within the configuration data 535, the manually-operable input controls 520, the speaker 570 and/or the display 580 may be caused to be operated by the processing component 555 to provide a user interface (UI) that enables manual entry of such associations during pairing of the alert device 500 with the multiple whisker sensors 100 installed on the one or more flow racks 700 that define the path along which an item 900 is to be moved.

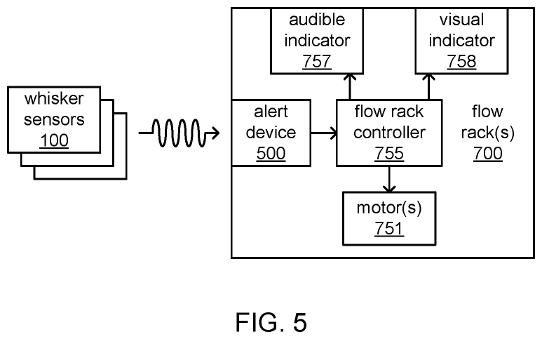

Turning to FIG. 5, an alternate example of the alert device 500 is depicted that is able to be at least connected to components of a motorized form of one or more flow racks 700. More specifically, this embodiment of the alert device 500 may be coupled to a flow rack controller 755 of one or more flow racks 700 that may be motorized such that rollers thereof are caused to spin to actively move an item 900 therealong. The flow rack controller 755 may control various functions of the one or more flow racks 700 by controlling the operation of the motor(s) 751 thereof. Alternatively or additionally, such a flow rack controller 755 may be involved in operating a speaker 757 and/or lights 758 of the one or more flow racks 700.

Thus, through such a connection with such a flow rack controller 755, the processor component 555 in such an embodiment of the alert device 500 may be caused by execution of the control routine 540, and in response to a determination that an item 900 has become stuck and/or lost along the path defined by the one or more flow racks 700, to interact with the flow rack controller 755 to operate the audible indicator 757 and/or the visual indicator 758 thereof to provide an audible and/or visual alert, and/or to operate the motor 751 to stop the active moving of items 900 along that path.

1. A sensor assembly comprising a mounting shell configured to enable mounting of the sensor assembly to a portion of a flow rack, wherein:
the mounting shell defines an interior cavity to protectively enclose a casing of a kinetic switch;
the mounting shell defines a slot-shaped opening through to the interior cavity;
the kinetic switch comprises a lever that emanates from the casing of the kinetic switch, that is movable along a limited range of movement of a lever pathway between a resting position and a non-resting position, and that extends into the slot shaped opening when the kinetic switch is enclosed within the interior cavity;
a biasing force is exerted on the lever to bias the lever toward the resting position;
the kinetic switch comprises a transmitter to transmit a radio frequency (RF) signal in response to at least one of movement of the lever away from the resting position or movement of the lever into the resting position;
the slot-shaped opening is shaped and sized to enable the lever to be connected to one end of an elongate rod-like curving whisker that is formed from flexible material;
the flexible material of the whisker is sufficiently stiff as to enable an exertion of force on an opposite end of the whisker to overcome the biasing force and move the lever away from the resting position along the lever pathway toward the non-resting position;
the slot-shaped opening is shaped and sized to constrain movement of the one end of the whisker to moving the lever along the lever pathway between the resting position and the non-resting position to thereby protect the whisker sensor by preventing use of the whisker to move the lever out of the limited range of movement of the lever pathway; and
in preventing use of the whisker to move the lever out of the limited range of movement of the lever pathway, the flexible material of the whisker is sufficiently less stiff than material from which the mounting shell is formed to cause the whisker to bend or break at a location between the one end and the opposite end thereof in response to an exertion of force on the whisker in a direction that would otherwise cause movement of the lever out of the lever pathway.

2. The sensor assembly of claim 1 comprising at least one of the kinetic switch or the whisker.

3. The sensor assembly of claim 1, wherein the mounting shell comprises a pair of shell components, wherein:
each shell component of the pair of shell components defines an inner surface having portions that are caused to face toward and engage corresponding portions of the inner surface of the other shell component when the pair of shell components are assembled to form the mounting shell; and
the inner surface of at least one shell component of the pair of shell components defines a first channel that serves to define a portion of the slot-shaped opening.

4. The sensor assembly of claim 3, wherein:
the inner surface of at least one shell component of the pair of shell components defines a second channel that serves to define a portion of an antenna opening through to the interior cavity; and
the kinetic switch comprises an antenna that emanates from the casing of the kinetic switch that extends into the antenna opening when the kinetic switch is enclosed within the interior cavity, and that is connected to the transmitter to cooperate with the transmitter to transmit the RF signal.

5. The sensor assembly of claim 1, wherein a plurality of passages are defined through portions of the mounting shell to enable mounting of the sensor assembly to the portion of the flow rack.

6. The sensor assembly of claim 5, wherein the mounting shell comprises a flange through which the plurality of passages are defined.

7. The sensor assembly of claim 1, wherein:
the portion of the flow rack comprises a tubular component of the flow rack; and
the mounting shell comprises a pipe clamp to enable mounting of the sensor assembly to the tubular component.

8. A flow rack monitoring system comprising:
at least one sensor assembly to be mounted to at least one portion of at least one flow rack to monitor movement of at least one item therealong, wherein:
each sensor assembly of the at least one sensor assembly comprises a kinetic switch;
the kinetic switch of each sensor assembly comprises a lever that is movable along a limited range of movement of a lever pathway between a resting position and a non-resting position;
the lever of the kinetic switch of each sensor assembly is connected to one end of an elongate rod-like curving whisker that is formed from flexible material, and that extends away from the kinetic switch to enable the whisker to extend into a path of travel of the items along the at least one flow rack; and
the kinetic switch of each sensor assembly comprises a transmitter to transmit a first radio frequency (RF) signal in response to movement of the lever away from the resting position, and a second RF signal in response to movement of the lever into the resting position; and
an alert device comprising a processor component and a storage that stores a control routine comprising executable instructions operable on the processor component to cause the processor component to:
operate a receiver to receive the first and second RF signals transmitted by each the sensor assembly of the at least one sensor assembly; and
in response to the receipt of the first RF signal from a first sensor assembly of the at least one sensor assembly, and in response to a lack of receipt of the second RF signal from the first sensor assembly within a first predetermined period of time, provide an audible indication or a visual indication of a possibility of a first item of the at least one item having become stuck along the at least one flow rack near the first sensor assembly.

9. The flow rack monitoring system of claim 8, wherein the first sensor assembly comprises a mounting shell configured to enable mounting of the first sensor assembly to a portion of a flow rack of the at least one flow rack, wherein:
the mounting shell defines an interior cavity to protectively enclose a casing of the kinetic switch;
the mounting shell defines a slot-shaped opening through to the interior cavity;
the lever of the first kinetic switch is movable along a limited range of movement of a lever pathway between the resting position and the non-resting position;
the lever extends into the slot shaped opening when the kinetic switch is enclosed within the interior cavity;
a biasing force is exerted on the lever to bias the lever toward the resting position;
the slot-shaped opening is shaped and sized to enable the lever to be connected to one end of the whisker;
the flexible material of the whisker is sufficiently stiff as to enable an exertion of force on an opposite end of the whisker to overcome the biasing force and move the lever away from the resting position along the lever pathway toward the non-resting position;
the slot-shaped opening is shaped and sized to constrain movement of the one end of the whisker to moving the lever along the lever pathway between the resting position and the non-resting position to thereby protect the whisker sensor by preventing use of the whisker to move the lever out of the limited range of movement of the lever pathway; and
in preventing use of the whisker to move the lever out of the limited range of movement of the lever pathway, the flexible material of the whisker is sufficiently less stiff than material from which the mounting shell is formed to cause the whisker to bend or break at a location between the one end and the opposite end thereof in response to an exertion of force on the whisker in a direction that would otherwise cause movement of the lever out of the lever pathway.

10. The flow rack monitoring system of claim 9, wherein the mounting shell comprises a pair of shell components, wherein:
each shell component of the pair of shell components defines an inner surface having portions that are caused to face toward and engage corresponding portions of the inner surface of the other shell component when the pair of shell components are assembled to form the mounting shell; and
the inner surface of at least one shell component of the pair of shell components defines a first channel that serves to define a portion of the slot-shaped opening.

11. The flow rack monitoring system of claim 10, wherein:
the inner surface of at least one shell component of the pair of shell components defines a second channel that serves to define a portion of an antenna opening through to the interior cavity; and
the kinetic switch comprises an antenna that emanates from the casing of the kinetic switch that extends into the antenna opening when the kinetic switch is enclosed within the interior cavity, and that is connected to the transmitter to cooperate with the transmitter to transmit the RF signal.

12. The flow rack monitoring system of claim 8, wherein:
the alert device comprises at least one of a speaker or a display; and
the processor component is caused to operate the speaker to provide the audible indication or to operate the display to provide the visual indication.

13. The flow rack monitoring system of claim 8, wherein:
the at least one flow rack comprises a flow rack controller;
the at least one flow rack comprises at least one of a speaker or a display; and
the processor component is caused to interact with the flow rack controller to operate the speaker to provide the audible indication or to operate the display to provide the visual indication.

14. The flow rack monitoring system of claim 8, wherein:
the at least one flow rack comprises a flow rack controller;
the at least one flow rack comprises at least one motor operated by the flow rack controller to cause movement of the at least one item along the at least one flow rack; and
in response to the receipt of the first RF signal from a first sensor assembly of the at least one sensor assembly, and in response to the lack of receipt of the second RF signal from the first sensor assembly within a first predetermined period of time, the processor component is caused to interact with the flow rack controller to cause a motor of the at least one motor to stop.

15. The flow rack monitoring system of claim 8, wherein the processor component is caused to:
in response to the receipt of the second RF signal from the first sensor assembly, and in response to a lack of receipt of the first RF signal, within a second predetermined period of time, from a second sensor assembly of the at least one sensor assembly that follows the first sensor assembly along a path of travel of a second item of the at least one item, provide an audible indication or a visual indication of a possibility of the second item having become stuck or having become lost along the path of travel of the second item between the first and second sensor assemblies.

16. The flow rack monitoring system of claim 15, wherein:
the at least one flow rack comprises a flow rack controller;
the at least one flow rack comprises at least one motor operated by the flow rack controller to cause movement of the at least one item along the at least one flow rack; and
in response to the receipt of the second RF signal from the first sensor assembly, and in response to the lack of receipt of the first RF signal from the second sensor assembly within the second predetermined period of time, the processor component is caused to interact with the flow rack controller to cause a motor of the at least one motor to stop at a location between the first and second sensor assemblies.

17. A method of monitoring movement of at least one item along at least one flow rack, comprising:
operating, by a processor component of an alert device of a flow rack monitoring system, a receiver of the alert device to receive first and second RF signals transmitted by each sensor assembly of at least one sensor assembly mounted to at least one portion of the at least one flow rack, wherein:
each sensor assembly of the at least one sensor assembly comprises a kinetic switch;
the kinetic switch of each sensor assembly comprises a lever that is movable along a limited range of movement of a lever pathway between a resting position and a non-resting position;
the lever of the kinetic switch of each sensor assembly is connected to one end of an elongate rod-like curving whisker that is formed from flexible material, and that extends away from the kinetic switch to enable the whisker to extend into a path of travel of the items along the at least one flow rack; and
the kinetic switch of each sensor assembly comprises a transmitter to transmit the first radio frequency (RF) signal in response to movement of the lever away from the resting position, and the second RF signal in response to movement of the lever into the resting position; and
in response to the receipt of the first RF signal from a first sensor assembly of the at least one sensor assembly, and in response to a lack of receipt of the second RF signal from the first sensor assembly within a first predetermined period of time, operating a speaker to provide an audible indication or operating a display to provide a visual indication of a possibility of a first item of the at least one item having become stuck along the at least one flow rack near the first sensor assembly.

18. The method of claim 17, wherein:
the at least one flow rack comprises at least one motor to cause movement of the at least one item along the at least one flow rack; and
the method further comprises, in response to the receipt of the first RF signal from a first sensor assembly of the at least one sensor assembly, and in response to the lack of receipt of the second RF signal from the first sensor assembly within a first predetermined period of time, stopping a motor of the at least one flow rack.

19. The method of claim 17, further comprising:
in response to the receipt of the second RF signal from the first sensor assembly, and in response to a lack of receipt of the first RF signal, within a second predetermined period of time, from a second sensor assembly of the at least one sensor assembly that follows the first sensor assembly along a path of travel of a second item of the at least one item, operating the speaker to provide an audible indication or operating the display to provide a visual indication of a possibility of the second item having become stuck or having become lost along the path of travel of the second item between the first and second sensor assemblies.

20. The method of claim 19, wherein:
the at least one flow rack comprises at least one motor to cause movement of the at least one item along the at least one flow rack; and
the method further comprises, in response to the receipt of the second RF signal from the first sensor assembly, and in response to the lack of receipt of the first RF signal from the second sensor assembly within the second predetermined period of time, stopping a motor of the at least one motor at a location between the first and second sensor assemblies.
